(19) United States
(12) Patent Application Publication
(10) Pub. No.: US 2006/0111087 A1
(43) Pub. Date: May 25, 2006

(54) Generation of service agreements for the use of network internal functions in telecommnication networks

(75) Inventors: Manfred Leitgeb, Gramatneusiedl (AT); Joerg Swetina, A-Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschatt, Munchen (DE)

(21) Appl. No.: 10/521,314

(22) PCT Filed: Jun. 11, 2003
(86) PCT No.: PCT/DE03/01941

§ 371 Date: Aug. 30, 2005

(30) Foreign Application Priority Data
Jul. 15, 2002 (DE) 102 31 972.3

(51) Int. Cl. H04Q 7/38

(52) U.S. Cl. 455/414.1

(57) ABSTRACT

Network internal functions of a telecommunication network can be access from an external site (Se), for example, a server, for the running of external services for network users (Mo), whereby the access is achieved by means of a secure service interface device (S2) on a network (“access network”) on the basis of a service agreement, valid for said service interface, in the favour of the external site (Se). According to the invention, in order to achieve access to functions in an other network (target network), as a result of a request (3) for a network internal function, sent to the interface device (S2) from the external site (Se), said interface checks for whether the request comprises the use of a function of the target network. Where the above is the case, a service agreement (4) (transitive agreement) is concluded between the interface device (S2) and a secure service interface device (S1) of B the target network. The request (5) is further transmitted and processed by means of the interface devices (S1,S2) on the basis of said transitive agreement.

### CLAIM FOR PRIORITY

This application is a national stage of PCT/DE2003/001941, published in the German language on Feb. 26, 2004, which claims the benefit of priority to German Application No. 102 31 972.3, filed on Jul. 15, 2002.

### TECHNICAL FIELD OF THE INVENTION

The invention relates to a method for accessing network-internal functions in telecommunication networks from an external site.

### BACKGROUND OF THE INVENTION

In modern mobile radio networks, e.g. the known UMTS system, external providers are able to offer network users services via the mobile radio network, such as local information services (e.g. request for nearest gas station), messaging services (e.g. chat rooms), games, etc. External providers here are understood to be devices or enterprises which do not themselves operate or maintain a communication network or support a network operator in the tasks required to operate a network. The services they offer are hereafter referred to as external services or third-party services.

An external service is often operated via a secure service access interface SSAI of the relevant network. Use of such a service access interface is based on a service level agreement SLA between the provider and the network operator. Naturally the number of service level agreements that an external provider concludes with networks is limited and a provider will generally only offer a service level agreement with networks in the catchment area (usually a country or state) of which the provider or its devices implementing the service is located. It can therefore happen that a user located in the catchment area of another network (visited network) instead of in their own network and wishing to use an external service available in the visited network is denied the use of the service, because the service requires access to user-related data and this is not possible because no adequate agreement exists between the service provider and the home network. Such a situation results in particular because the home network of the user does not have an agreement with said network (access network) for the provider to provide its external service.

For the mobile radio network services most frequently used at present (so-called legacy services) the problem of limited use options does not exist, as the legacy services represent standard services provided directly by the networks. The mobility of such services is guaranteed at network level by the mobility mechanisms inherent in the mobile networks.

### SUMMARY OF THE INVENTION

The invention relates to a method for accessing network-internal functions in telecommunication networks from an external site, with access being achieved via a secured service interface device of a network on the basis of a service agreement in favor of the external site and valid for the service interface.

One embodiment of the invention discloses use of network-internal service functions, in particular for access to user-related data, by external services even when the service functions are requested via a different network.

In another embodiment according to the invention, there is a method in which it is verified on the part of the secure service interface device (SSAI) on the basis of a request sent to it from the external site, whether the request involves the use of a function of another network (target network) and if so, a second request relating to the functions of this network is then exchanged between the interface devices on the basis of a service level agreement concluded between the interface device and a secure service interface device of the target network (transitive agreement).

In one aspect of the invention, the target network corresponds to the home network of the user using the service, so that access takes place in the context of a service, which is executed by the external site for a user, the home network of which is the target network. The invention hereby permits the use of user-related data in a simple manner, without undue infringement of data protection interests.

The transitive agreement can already exist; in other words it can have been concluded before the start of the service. Alternatively the transitive agreement can be concluded with a second network in each instance on the basis of the first request relating to the network, with the agreement being valid for the duration of the service or continuing thereafter at the discretion of the operator.

As a basis for the transitive agreement, it is generally a requirement that there is a valid service level agreement between the service provider and the access network and similarly a service level agreement (for example together with a roaming agreement) exists between the access network and the target network—in other words generally the home network of the user using the service. In such a case it is expedient for the transitive agreement to be generated as a service level agreement in favor of the external site, in so far as there is a roaming agreement between the networks operating as mobile radio networks and a service level agreement on the part of the access network in favor of the external site.

As stated above, the external site can be a server for external services which are executed using network-internal services in the area of the access network (or a visited network available via the access network) for users that are connected or logged in.

It is also advantageous if messages exchanged between the external site and the target network further to the second request are transmitted via the interface devices, with the interface device of the access network transparently forwarding messages exchanged between the external site and the interface device of the target network. If the messages further to the second request are exchanged between the external site and network centers of the target network, the messages can be transmitted via the interface device of the access network such that the interface device forwards the messages as a transparent proxy server.

### BRIEF DESCRIPTION OF THE DRAWINGS

The invention is described in more detail below with reference to exemplary embodiments. The drawings are referenced for this purpose, in which:

FIG. 1 shows the networks and network components involved in the exemplary embodiment.

FIG. 2 shows a flow diagram of the signals for the initiation of an external service.

It should be noted here that only the components and devices necessary to illustrate the invention are shown in the Figures. Other devices, in particular switching units and connection elements, are obvious to the person skilled in the art and are therefore not shown.

### DETAILED DESCRIPTION OF THE INVENTION

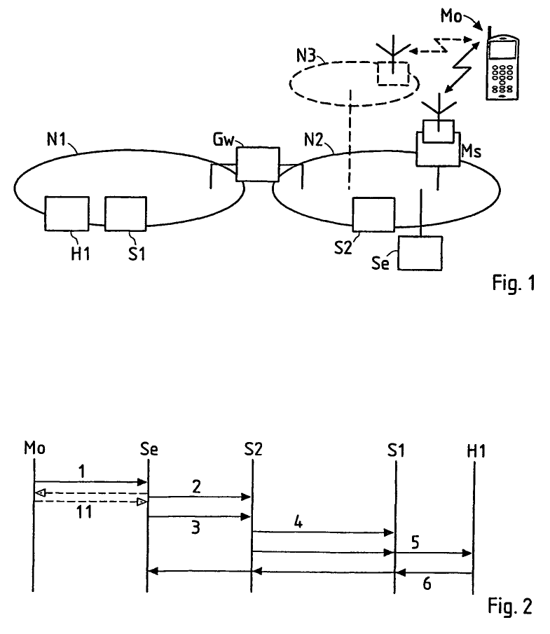

As shown in FIG. 1, the user of a mobile telephone Mo is located as a mobile user in the catchment area of a mobile radio network N2, which is for example set up in the known manner for example as a UMTS network and is connected in the known manner via a gateway Gw to the home network N1 of the user Mo. The network N2 therefore serves the user Mo as a visited network, to which the user is connected via the base station of a mobile switching center Ms, which also manages user-related data in a temporary manner in the form of a visitor register. A home register H1, also referred to as a home location register HLR, is provided in the home network N1 for the storage of significant user data, in particular permanent and quasi-permanent data, such as call number, device type, subscribed services, etc. and temporary data such as current location.

An external service provider provides a service, for example and information service, by means of a server device Se connected to the mobile radio network N2, the service operating as an application program on the server and being provided via a WAP page. When executed, the service accesses the services of the network N2, e.g. for charging purposes. A secure service interface device S2 is set up in the network N2 as a network device for access to network-internal services of the network N2 by external providers and a secure service interface device S1 is set up similarly in the network N1 with particular responsibility for providers (not shown) connected there.

The network N2 therefore operates as an access network for external services provided from the server Se.

A secure service interface device—hereafter abbreviated to SSAI—of a network is an electronic interface, which is established on the basis of existing standards or other regulations and allows services of external providers in a position of trust to access network-internal functions, e.g. call control, charge functions and user profile requests. One example of an SSAI is the so-called OSA (open service access) interface, which is defined by the 3GPP in the standard TS 22.127. More detailed information about the 3GPP consortium and assigned standards is available on the internet at: http://www.3gpp.org.

A service level agreement should exist for an external provider to be authorized to utilize access in respect of an SSAI. Such a service level agreement—hereafter abbreviated to SLA—provides the basis for access authorization and authentication of the service or the server executing the service. An SLA is generally based on a contract between the external provider and the operator of the SSAI or the relevant network and is stored on the SSAI in electronic form, e.g. in a specific file or as an entry in a database. If a network operator—e.g. the operator of the network N2—permits the provider of an external service to access network functions (set out in the relevant contract) via the SSAI—in the example the SSAI S2—the SSAI is set up such that the service server Se of the provider is authorized for such access after corresponding authentication. Authentication of the service or server Se can be effected electronically, e.g. by transmitting one or a plurality of SLA certificates to the SSAI S2, with a suitable protocol for the service request—in the example the OSI-API according to 3GPP TS 29.198—being used for the exchange of messages between the server Se and the SSAI S2.

The service functions are generally accessed within a session which is initiated between the sites involved (in this instance the sites Se, S2), e.g. for the duration of execution of the service. At the start of the session a so-called electronic SLA is set up, which is valid for said session, by the above-mentioned authentication by means of SLA certificate(s).

It should be noted that for UMTS networks (such as the networks N1, N2 in the exemplary embodiment) the SSAI devices are set up as OSA gateways. There is currently no communication between the OSA gateways S1, S2 of different UMTS network N1, N2 to allow an exchange of SLA certificates. According to the invention, this shortcoming is eliminated in that a “transitive” electronic SLA is set up between the SSAI sites and further dialog takes place between the sites in the nature of the dialog between an SSAI and an external server. This is described in more detail below.

The signal flow diagram in FIG. 2 shows the messages which are exchanged to initiate a service between the service server Se, the user Mo and the network stations S1, S2. In FIG. 2, the vertical axis represents time (downwards) and the individual network centers are symbolized as vertical lines.

When the user Mo requests an external service from the provider, said user sends a request 1 of the known type via the visited network N2, in which the user is located, to the server Se. This request can be made in different ways, for example in the form of a telephone call via a service number assigned to the server Se, via access to an internet site or a WAP site, etc. The relevant external service is then implemented on the part of the server Se for the user Mo, with the option of a dialog 11 with the user.

As stated above, it is often the case that the service also requires access to functions of the home network of the user—or another target network, which is not the access network—e.g. charging, perhaps to pay for special services. If no SLA exists between the home network N1 and the service provider or the latter's server Se, according to the invention functions are accessed on the basis of an existing SLA between the provider/server Se and the access network N2 and an access option between the networks (in this instance the target network N1 and the access network N2) in the form of “transitive SLAs” as described in more detail below.

In the case of the exemplary embodiment the visited network and the access network N2 are the same. Generally, as indicated in FIG. 1 by the broken line of the network N3, these can be different, with communication between the server Se (connected via the access network N2) and the user Mo in the visited network N3, which then serves as a transport network, taking place in the known manner. In a further constellation the user could be located in the target network—i.e. the visited network N3 and target network N1 are identical—and use an external service, access to which is effected via a different access network N2. Irrespective of these specific constellations, the processes of significance to the invention operate between the server Se and the devices of its access network N2 and the devices of the target network N1.

Instead of the server Se communicating with the SSAI S1 of the home network N1 of the user Mo—which is of course not possible without an SLA between said sites—according to the invention network-internal services are accessed via the SSAI S2 of the access network N2, where there is an SLA as required.

To use network services a session is set up between the server Se and the SSAI S2. First the server Se sends an SLA certificate 2 to the access network SSAI S2 to set up an electronic SLA, which serves as the basis of authentication for the session; this SLA is primarily only valid for the session between the server Se and the SSAI S2 in the network N2. A request 3 is then sent for a network service function, e.g. for the charging of a specific amount, with said request generally containing further data, in particular the ID of the user Mo (e.g. said user's IMSI or TMSI) and if required the identity of the target network N1.

The request 3 is received and evaluated on the part of the access network SSAI S2. It is thereby identified that the request requires network services of another target network, in this instance the home network N1. According to the invention therefore in the next step a “transitive SLA” is set up with the SSAI S1 of the target network by the SSAI S2 sending an SLA certificate 4 to the SSAI S1 of the target network N1.

A session is thereby initiated between the SSAI sites S1, S2, which, together with the session between the SSAI S2 and the server Se in the access network N2, according to the invention generally allows communication between the server Se and the target network SSAI S1. For this to take place, the access network SSAI S2 is set up such that—in addition to its known function as a server for SSAI transactions—it can send requests as a client to another SSAI and receive corresponding server responses from there. Advantageously, the same protocol is used for this as is used between the SSAI S2 and the external server Se, e.g. the OSA API referred to above.

The target network SSAI S1 is also expediently set up so that a service request and an SLA can be requested from an SSAI S2 of another network, with which for example a roaming agreement exists; this access option therefore exists in addition to those of the external providers (not shown), for which an SLA exists with the SSAI S1 and in an essentially equivalent manner thereto. Such access can be set up in the same way as for an external provider, generally by corresponding configuration or administration of the settings of the SSAI S1, based for example on a roaming agreement or another agreement between the operators of the networks involved N1, N2.

Once the transitive SLA has been set up between the SSAI sites S1, S2, requests 5 can be sent to the SSAI S1, which the latter forwards as required as a function of the respective request to other network stations of the target network. The SSAI S2 hereby forwards the messages exchanged between the terminal sites S1, Se in a transparent manner. The access network SSAI S2 hereby receives requests from the server Se and forwards them in the dialog held with the SSAI S1 to the latter; responses from the SSAI S1 are in turn routed back to the server Se.

In the instance considered here, namely charging, the request is sent to the home register N1 of the home network N1. For further messages exchanged between the server Se and the target network N1, e.g. the charging confirmation 6 of the home register H1, the SSAI devices S1, S2 serve as transparent proxy stations, via which the relevant messages and responses are forwarded.

In the process described above, the transitive SLA is concluded for the duration of a session and therefore only covers the transaction associated with the service request. A new transitive SLA is therefore be concluded in the event of another, in particular a later or for some other reason separate service request or transaction. However, in a variation, the transitive SLA can be set up permanently so that step 4 of FIG. 2 would not be required for further service requests. Instead, the existence of an (already concluded) transitive SLA would be verified at this point on the part of the SSAI S1 and S2. A transitive SLA is then set up 4 if an SLA does not exist (or has expired in the meantime). In other words, the SLA between the SSAI devices S1, S2 does not have to be concluded at the time of the specific request 3 but can already have been set up before this.

It should be noted that the process described using the above exemplary embodiment is given as an example and is not restrictive for the invention. Rather, the invention can be used in more general instances, as long as the following conditions are satisfied:
the telecommunication networks involved (two or more) each have an SSAI;
the necessary protocols (e.g. an OSA protocol) for setting up an SLA exist between the networks involved or the associated SSAI devices;
the external site (e.g. the external service provider) has an SLA with one of the networks involved.

Subject to the above conditions the invention allows a transitive SLA to be set up with the relevant target network, which is required to respond to the respective service request, from the network, with which the external site has agreed an SLA.

What is claimed is:

1. A method for accessing network-internal functions of telecommunication networks, from an external site, with access taking place via a secure service interface device of a network based on a service level agreement valid for the service interface in favor of the external site, comprising:
verifying, on the part of the interface device, based on a request sent to it from the external site relating to a network-internal function, whether the request involves use of a function of another network; and
when the request uses a function of another network, exchanging a second request relating to the functions of the network between the interface devices based on the a service level agreement concluded between the interface device and a secure service interface device of the target network.

2. The method according to claim 1, wherein
access takes place in the context of a service, which is executed by the external site for a user, the home network of which is the target network.

3. The method according to claim 1, wherein
the service level agreement is generated in a manner favorable to the external site, such that a roaming agreement exists between the networks set up as mobile radio networks and the service level agreement exists on a part of the access network favorable to the external site.

4. The method according to claim 1, wherein the external site is a server for external services, which are executed in an area of the access network or a visited network accessible via the access network using network-internal services for users that are connected or logged in.

5. The method according to claim 1, wherein
messages exchanged further to the second request between the external site and the target network are transmitted via the interface devices, with the interface device of the access network forwarding messages exchanged between the external site and the interface device of the target network in a transparent manner.

6. The method according to claim 1, wherein
messages exchanged further to the second request between the external site and network centers of the target network are transmitted via the interface device of the access network, with the interface device forwarding the messages as a transparent proxy server.

7. A network device of a telecommunication network, which is set up as a secure service interface device to verify, on the part of an interface device, based on a request sent thereto from an external site relating to a network-internal function, whether the request involves use of a function of another network; and when the request uses a function of another network, exchanging a second request relating to the functions of the network between the interface devices based on a service level agreement concluded between the interface device and a secure service interface device of the target network.
